(19) United States
(12) Patent Application Publication
(10) Pub. No.: US 2024/0259375 A1
(43) Pub. Date: Aug. 1, 2024

(54) POLICY GENERATION APPARATUS, POLICY GENERATION METHOD, AND NONTRANSITORY COMPUTER READABLE MEDIUM STORING PROGRAM

(71) Applicant: NEC Corporation, Minato-ku, Tokyo (JP)

(72) Inventors: Shohei MITANI, Tokyo (JP); Taniya SINGH, Tokyo (JP); Nakul GHATE, Tokyo (JP); Hirofumi UEDA, Tokyo (JP)

(73) Assignee: NEC Corporation, Minato-ku, Tokyo (JP)

(21) Appl. No.: 18/290,363

(22) PCT Filed: May 20, 2021
(86) PCT No.: PCT/JP2021/019149

§ 371 Date: Nov. 13, 2023

(51) Int. Cl. H04L 9/40

(52) U.S. Cl. CPC H04L 63/10

(57) ABSTRACT

A policy generation apparatus according to one example embodiment of the present disclosure includes at least one memory configured to store instructions; and at least one processor configured to execute the instructions to: acquire, regarding a plurality of elements related to access control, relation data indicating a relation between a plurality of elements and score data that defines at least one of a score which is based on a viewpoint of risk of access or a score which is based on a viewpoint of a need for access; and generate a policy for access control using the relation data and the score data.

### TECHNICAL FIELD

The present invention relates to a policy generation apparatus, a policy generation method, and a non-transitory computer readable medium storing a program.

### BACKGROUND ART

Access control in a network is important for security of the network and maintenance of access that is necessary.

For example, Cited Document 1 discloses an access control system configured to generate an access control policy using a relation or the like between an object group and an object and generate access control lists that are different for each access control implementing means for controlling access to an object. An object of this access control system is to describe, even if objects in which combinations with actions are different, such as Operating Systems (OS) in which file systems are different are mixedly present and access control implementing means of many types are connected at the same time, access control policy by a same method and system as the conventional method and system, and the access control can be collectively executed.

### CITATION LIST

### Patent Literature

[Patent Literature 1] Japanese Patent No. 5424062

### SUMMARY OF INVENTION

### Technical Problem

This disclosure provides a policy generation apparatus, a policy generation method, and a non-transitory computer readable medium storing a program capable of reducing the time and effort human beings require.

### Solution to Problem

A policy generation apparatus according to one example embodiment includes: acquisition means for acquiring, regarding a plurality of elements related to access control, relation data indicating a relation between the plurality of elements and score data that defines at least one of a score which is based on a viewpoint of risk of access or a score which is based on a viewpoint of a need for access; and policy generation means for generating a policy for access control using the relation data and the score data.

A policy generation method according to one example embodiment is a policy generation method executed by a computer, the policy generation method including: acquiring, regarding a plurality of elements related to access control, relation data indicating a relation between the plurality of elements and score data that defines at least one of a score which is based on a viewpoint of risk of access or a score which is based on a viewpoint of a need for access; and generating a policy for access control using the relation data and the score data.

A non-transitory computer readable medium according to one example embodiment stores a program for causing a computer to execute the processing of: acquiring, regarding a plurality of elements related to access control, relation data indicating a relation between the plurality of elements and score data that defines at least one of a score which is based on a viewpoint of risk of access or a score which is based on a viewpoint of a need for access; and generating a policy for access control using the relation data and the score data.

### Advantageous Effects of Invention

According to this disclosure, it is possible to provide a policy generation apparatus, a policy generation method, and a non-transitory computer readable medium storing a program capable of reducing the time and effort human beings require.

### BRIEF DESCRIPTION OF DRAWINGS

FIG. 1 is a block diagram showing one example of a policy generation apparatus according to a first example embodiment;

FIG. 2 is a flowchart showing one example of processing of the policy generation apparatus according to the first example embodiment;

FIG. 3 is a block diagram showing one example of a policy generation system according to a second example embodiment;

FIG. 4 is a schematic view showing one example of an algorithm for generating a policy according to the second example embodiment;

FIG. 5 is a schematic view showing one example of a table showing the policy according to the second example embodiment;

FIG. 6 is a block diagram showing one example of a policy generation system according to a third example embodiment; and

FIG. 7 is a block diagram showing one example of a hardware configuration of an apparatus according to each example embodiment.

### EXAMPLE EMBODIMENT

### First Example Embodiment

Hereinafter, with reference to the drawings, a first example embodiment of the present disclosure will be described.

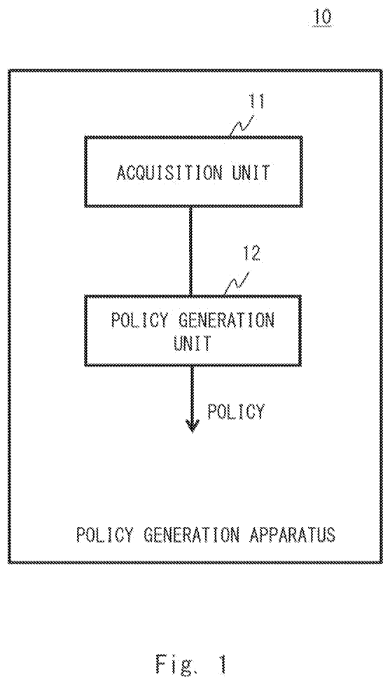

FIG. 1 is a block diagram showing one example of a policy generation apparatus. A policy generation apparatus 10 includes an acquisition unit 11 and a policy generation unit 12. Each part (each means) of the policy generation apparatus 10 is controlled by a control unit (controller) that is not shown. Hereinafter, each part will be described.

The acquisition unit 11 acquires, regarding a plurality of elements related to access control, relation data indicating a relation between a plurality of elements and score data that defines at least one of a score which is based on a viewpoint of risk of access or a score which is based on a viewpoint of a need for access. Note that the acquisition unit 11 is formed of an interface that acquires information from inside the policy generation apparatus 10 or from outside thereof. The acquisition processing may be automatically executed by the acquisition unit 11 or may be executed by manual input.

The “elements related to access control” indicate arbitrary information related to access control. The elements may specifically include an arbitrary ID or attributes related to access control, such as various kinds of data of an access source, a connection port, a destination Internet Protocol (IP) address, an access time period (or time), a resource ID of a target to be accessed, etc. Specific examples of various kinds of data of the access source include, for example, but not limited to, an IP address of the access source, a user ID, a device ID, an application ID, a user's location, and an OS used by access source equipment.

Further, “elements related to access control” may include not only a single element but also any combination of different elements. The combinations may be, for example, but not limited to, a combination of elements having different attributes, like (user ID×user's location×resource ID) or a combination of elements having the same attribute such as an IP address, like (source IP address×destination IP address). Further, the number of elements to be combined may be any number equal to or larger than two. Hereinafter, these elements may also be referred to as “entities”.

Then, the “relation data indicating a relation between a plurality of elements” indicates a relation between different single elements, a relation between a combination of elements and a single element, or a relation between combinations of different elements. The relation data is, for example, data in which an inclusive relation or a logical relation is defined in a binary.

Further, the “score data” is data in which scores indicated by actual values are set. The “score based on the viewpoint of the risk of access” indicates an amount of loss when the access is unauthorized or erroneous or a likelihood that the unauthorized access or the like may occur, that is, a parameter for denying the access, and “the score based on the viewpoint of the need for access” indicates an amount of benefit obtained from the access or a probability that benefit can be obtained, that is, a parameter for permitting the access. Therefore, these parameters have values opposite from each other as attributes. For example, a negative value may be set as “the score based on the viewpoint of the risk of access”, whereas a positive value may be set as “the score based on the viewpoint of the need for access”. As another example, 0 or a value that is close to 0 may be set as “the score based on the viewpoint of the risk of access” and a value having a large absolute value may be set as “the score based on the viewpoint of the need for access”. Specific examples of the “relation data” and the “score data” will be described later in the second example embodiment.

The policy generation unit 12 is configured to generate a policy for access control using the relation data and the score data acquired by the acquisition unit 11. By using this policy, even in a dynamic case where there may be changes in the relation data or the score data, access control may be achieved by automatically re-generating a policy.

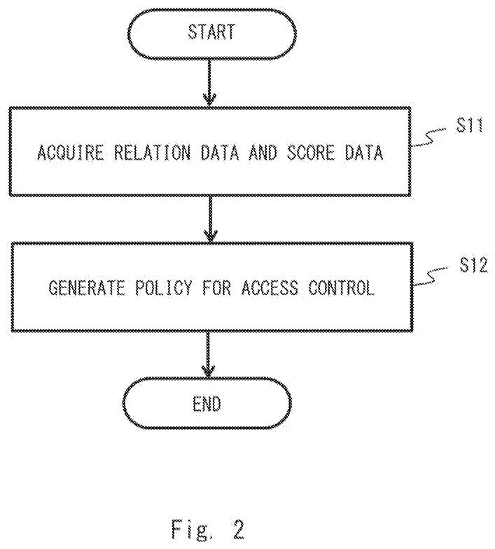

FIG. 2 is a flowchart showing one example of representative processing of the policy generation apparatus 10. The processing of the policy generation apparatus 10 can be described along with this flowchart. First, the acquisition unit 11 of the policy generation apparatus 10 acquires, regarding a plurality of elements related to access control, relation data indicating a relation between the plurality of elements and score data that defines at least one of a score which is based on a viewpoint of risk of access or a score which is based on a viewpoint of a need for access (Step S11; acquisition step). Next, the policy generation unit 12 is configured to generate a policy for access control using the relation data and the score data (Step S12; policy generation step).

As described above, the policy generation apparatus 10 is able to automatically generate a policy using relation data indicating a relation between a plurality of elements and score data. Therefore, it is not necessary for human beings to generate a policy in the first place, which reduces the time and effort human beings require to generate the policy. Further, since at least one of the risk or need for access is reflected in the score, the policy generation apparatus 10 is able to quantitatively evaluate the trade-off between benefit and loss caused by each access. Therefore, the policy generation apparatus 10 is able to maintain the security of the system by determining access control so as to reduce loss when access is unauthorized or erroneous, while maintaining the benefit obtained from the access.

### Second Example Embodiment

Hereinafter, with reference to the drawings, a second example embodiment of this disclosure will be described. In the second example embodiment, a specific example of the policy generation apparatus 10 described in the first example embodiment will be disclosed.

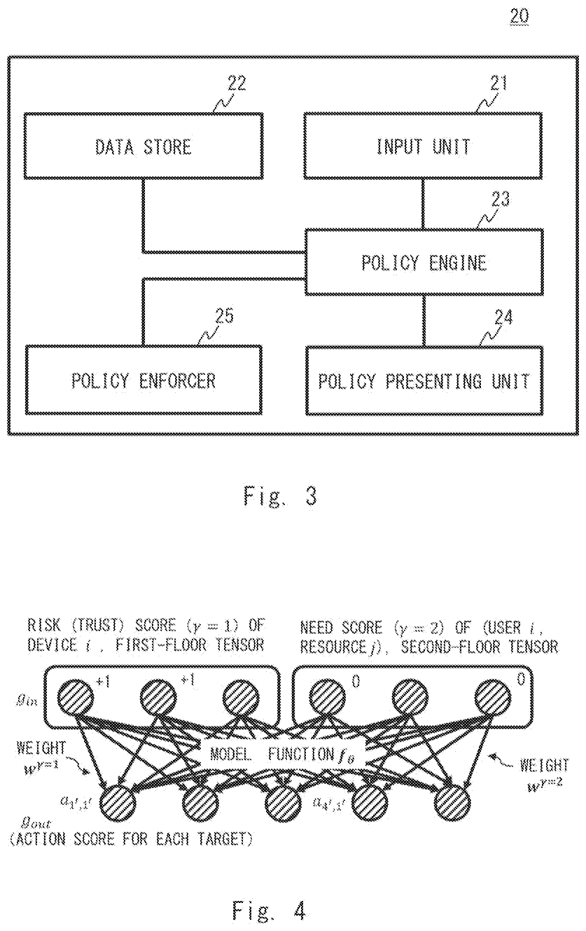

FIG. 3 is a block diagram showing one example of a policy generation system 20 on a zero trust network. The policy generation system 20 includes an input unit 21, a data store 22, a policy engine 23, a policy presenting unit 24, and a policy enforcer 25. Hereinafter, details of each part will be described.

The input unit 21 is an interface such as a keyboard, a button, or a mouse for enabling an administrator of the policy generation system 20 to input data. The data store 22 is a storage (storing unit) that stores data, and the policy generation system 20 stores automatically collected data in the data store 22. The input unit 21 and the data store 22 correspond to the acquisition unit 11 according to the first example embodiment, and output, to the policy engine 23, the relation data indicating a relation between a plurality of elements and the score data in which the score based on a viewpoint of risk of access and the score based on a viewpoint of a need for access are defined. At this time, at least one of the relation data or the score data manually input by the administrator is input from the input unit 21, and at least one of the relation data or the score data automatically collected by the policy generation system 20 is input from the data store 22.

The administrator is able to define the score of the need or risk in the score data and input this score from the input unit 21. For example, the administrator is able to set, regarding a specific user who makes access, this user's need to access a specific resource (access need). Specifically, the administrator may classify a plurality of users into a plurality of groups and set access needs of each group to specific resources. As one example, the administrator classifies each of user IDs into one of an “R&D” group and an “accounting” group. The administrator then sets, regarding the “R&D” group, access needs to the resource IDs of files of an experiment environment and experiment data to be “1” and sets access needs to the resource IDs of other files to be “0”. Further, the administrator sets, regarding the “accounting” group, access needs to the resource IDs of files of settlement information to be “1” and sets access needs to the resource IDs of other files to be “0”. Here, “1” indicates that there are access needs and “0” indicates that access needs cannot be defined. It is preferable that access to resources where there are access needs be permitted by a policy compared to access to resources where access needs cannot be defined. Accordingly, the administrator sets the score when there are access needs to be higher than the score when access needs cannot be defined.

Further, the administrator may also input, regarding a specific resource, a score from the viewpoint of other various kinds of data of the access source in addition to or in place of the user ID. Examples of other various kinds of data of the access source include an IP address, a device ID, an application ID, a user's location, or an OS used by an access source equipment. For example, the administrator may set, regarding a specific user, this user's need to access a specific resource from a specific place in a way similar to that stated above.

Further, the administrator may also set, regarding arbitrary one or more entities related to access control, needs to access a specific resource. Specific examples of the entities have already been described in the first example embodiment. The administrator may set, for example, a risk score in a specific time period (or time) of a specific resource.

Further, the administrator may set three or more types of scores for a specific resource. When, for example, there is a need for one user A to access a resource a in a time period of 12:00-15:00, the administrator sets the scores as follows.

$$Score ( User = A , Time = 12 : 00 - 15 : 00 , Resource = α ) = + 1 \qquad ( 1 )$$

Further, when no need is specifically defined, the score is set as follows.

$$Score ( User = A , Time = 12 : 00 - 15 : 00 , Resource = α ) = 0 \qquad ( 2 )$$

When the need is low, the score is set as follows.

$$Score ( User = A , Time = 12 : 00 - 15 : 00 , Resource = α ) = - 1 \qquad ( 3 )$$

In contrast, when the need is extremely high, the administrator sets the score as follows.

$$Score ( User = A , Time = 12 : 00 - 15 : 00 , Resource = α ) = 10 \qquad ( 4 )$$

In this manner, the administrator is able to set comprehensive access needs for a specific resource.

Further, the administrator may set, regarding a specific resource, the magnitude of a damage in a case where inappropriate access has been performed by a score as a risk. The administrator may set, for example, an absolute value of the score to increase as the importance of the resource increases.

Note that the policy generation system 20 automatically sets the score that has not been input by the administrator to a default value (e.g., 0). Even when the score has become a default value, access is not uniformly approved or denied in the policy generated by the policy engine 23. This point will be described later.

On the other hand, the data store 22 stores data mechanically collected regarding the policy generation system 20. This data includes relation data and score data. Further, this data relates to threat intelligence, an asset database, an inventory, operation needs, authentication, sensitivities of resources, an authentication server, audit software or sensors, Intrusion Detection System (IDS), Continuous Diagnostics and Mitigation (CDM), Security Information and Event Management (SIEM), Network Data Analytics Function (NWDAF), an activity log, ID management, Public Key Infrastructure (PKI), industry compliance, a risk analysis system, one or more other various information sources that are available. These information sources may be located on the zero trust network or may be located in the outside of the zero trust network. Further, the audit software or the sensors may be provided on the device.

Note that the audit software is, for example, software regarding at least one of security or asset management. The sensor is, for example, at least one of a Global Positioning System (GPS) sensor, a human sensor, or a temperature sensor, and may be actually provided in a building.

Regarding threat intelligence, data on threat information and vulnerability information provided by a security organization, or vulnerability information discovered through threat analysis of a system may be used. The threat information provided by the security organization relates to, for example, an IP address, a device ID, an application, a process, a communication signature or a manufacturer, behavior of a user or a network, a resource ID, a resource location, etc. that are suspected to be under threat. The vulnerability information provided by the security organization relates to, for example, device information on the OS, the manufacturer or the like, protocol, an encryption or authentication method, application information such as a version, or any combination thereof. The vulnerability information discovered through threat analysis of a system relates to, for example, a device ID, an IP address, an application, an ID of a command in association with a specific operation or a communication path thereof. Further, this vulnerability information may also include information about the combination on a case where a specific device is accessed by a specific port, a case where a specific application is used on a specific OS, or a case where a specific resource such as personal information or Internet of Things (IoT) equipment is accessed under a specific operation history such as a change in the access authority. These information items cause a negative contribution to access approval.

Further, from the authentication server, data regarding a method of authentication of a user, a device, an application or the like, the number of times of failure in the authentication, a time elapsed since the last successful authentication, behavior during authentication or time of authentication, or an authenticated user's location may be stored in the data store 22 as the authentication history. For example, a score indicating that a higher level of risk is set as the time elapsed since the last successful authentication increases. Further, from the IDS, data of suspicious behavior, signature or the like in a subnetwork address, an IP address, a port, an application, a device or the like in a network may be stored in the data store 22.

From the risk analysis system, data regarding various kinds of risks may be stored in the data store 22. Further, the data store 22 may store, as a score regarding needs, access needs by a communication history between specific users. Further, the data store 22 may store, as a risk score, a trust score indicating a degree to which a user, a device, an application, an IP address, or an ID of another entity, or any combination thereof can be trusted. This trust score is calculated using, for example, abnormality detection in an abnormality detection engine or an authentication history indicating successful authentication by a secure authentication method. The calculation itself of the trust score may be performed by means (not shown) such as a trust engine of the zero trust network. When the behavior of one entity is suspicious from a security perspective, a low trust score is given to this entity.

In the following, specific numerical values of the scores will be listed. For example, as the need scores determined from the communication history between the access source and the access destination, the following values are set.

$$Score ( SrcIP = 192.168.1 \text{.10} , DstIP = 192.168.1.1 ) = + 0.5 \qquad ( 5 )$$

$$Score\_ 2 ( User = B , Time = 12 : 00 - 15 : 00 , Resource = β ) = + 1.5 \qquad ( 6 )$$

(5) indicates the score regarding the source IP address and the destination IP address, and (6) indicates the score regarding a source user, a time period, and a resource. While (6) indicates the score regarding entities the same as those in (1) through (4), the score set in (6) is a different type of score to distinguish (6) from (1) through (4).

Further, as a score regarding a source equipment OS and a source browser, the following one may be set.

$$Score ( OS = * * * . ver \text{.19} \text{.01} , Application = * * * ) = - 1 \qquad ( 7 )$$

Further, as a score regarding the user, the following one may be set.

$$Score ( User = C ) = - 2 \qquad ( 8 )$$

When, for example, the output from the information source is a real number such as an abnormality, the data store 22 may directly store this output value. This is because the policy engine 23 that will be described later can directly use the output value as a score. Further, when the output from the information source is discrete information such as the presence or absence of threats, the value of the score may be set as a fixed binary value, such as “−1” for threats and “0” for non-threats. Alternatively, depending on the threat level, the score indicating the threat level can be set as three or more values, such as 0, −1, −2, −3, . . . . Further, normalization processing may be performed on the score as necessary. The setting of the values or the normalization processing stated above may be performed when the value is stored in the data store 22 or may be performed when the policy engine 23 performs policy generation processing.

Further, the data store 22 stores relation data indicating the current relation, the relation data being mechanically collected. The relation data indicates, for example, which application or port accesses a resource such as data, which device the user is using and which IP address is allocated to the device, topology between devices, a communication frequency or the like.

In the following, specific examples of the relation data will be listed. When, for example, the user A is using a device 1, not a device 2, the relation data is as follows.

$$relation ( ( User = A ) , ( Device = 1 ) ) = True , \\ relation ( ( User = A ) , ( Device = 2 ) ) = False \qquad ( 9 )$$

Further, when a port 1000 is used and a port 2000 is not used to access a resource r, the relation data is as follows.

$$relation ( ( Resource = r ) , ( Port = 1000 ) ) = True , \\ relation ( ( Resource = r ) , ( Port = 2000 ) ) = False \qquad ( 10 )$$

Further, regarding an inclusive relation between combinations regarding the user A, and a set of the user A and the resource a, examples of the relation data are as follows.

$$relation ( ( User = A , Resource = α ) , ( Resource = α ) ) = True , \\ relation ( ( User = A , Resource = α ) , ( Resource = β ) ) = False \qquad ( 11 )$$

Like described above, all the relations are expressed by True or False. The data store 22 is able to acquire these relation information items from an authentication server, an asset database, an inventory or the like.

Further, by using the relation data described above, the policy generation system 20 is able to calculate new relation data. When, for example, the access source user is A, the access destination resource is r, A uses the IP address 192.168.1.10, and the resource r is located at the IP address 192.168.1.1, the new relation data can be calculated as follows.

$$relation ( ( User = A , Resource = r ) , \\ ( SrcIP = 192.168 \text{.1} \text{.10} , DstIP = 192.168 \text{.1} \text{.1} ) ) = True , \\ relation ( ( User = A , Resource = r ) , \\ ( SrcIP = 192.168 \text{.1} \text{.10} , DstIP = 192.168 \text{.1} \text{.1} ) ) = False \qquad ( 12 )$$

As described above, the data store 22 is able to acquire score data and relation data regarding an arbitrary entity. Like the input unit 21, the policy generation system 20 automatically sets the score that has not been set to a default value (e.g., 0).

The policy engine 23 corresponds to the policy generation unit 12 according to the first example embodiment, and generates a policy as an authorization algorithm based on a policy generation algorithm using the score data and the relation data output from the input unit 21 and the data store 22. Here, regarding one access, targets of access control such as an IP address and a port, which are entities of the access source and the access destination, are each denoted by a target t, and the score data and the relation data stated above are set as a condition c for determining the way of controlling access of each target t. In this case, the policy is a list of ways of performing access control including Accept, Wait, and Drop of access to each target t. The policy is determined by associating the action score calculated by the following model function f_{θ} with the specific way (action) of performing access control.

$${f}_{θ} ( t , c ) = a \qquad ( 13 )$$

As described above, the condition c includes the score data defined by the administrator.

Note that, in order to generate an appropriate model function f_{θ}, when the risk goes up or the needs go down, there is a necessary condition that the action for access control be tightened to reflect the administrator's intention.

The policy engine 23 generates a monotonic model function f_{θ} for the score so that the necessary condition is satisfied. Since the model function f_{θ} is monotonic and the actions set by the policy are a totally ordered set, actions become order isomorphisms for each score of score data defined by actual values. While a function where weighted sums by non-negative numbers are used is defined and this function will be described as an example of the monotonic function in this example, the function is not limited thereto. Accordingly, when the needs go down or the risk goes up, the action changes so that the access will not be permitted. Therefore, the aforementioned necessary condition is satisfied.

FIG. 4 is an image view showing one example of an algorithm where the policy engine 23 generates a policy. Black circles in gᵢₙ shown in the upper part of FIG. 4 indicate scores regarding the respective conditions c and black circles in gₒᵤₜ indicate the respective targets t. The left side of gᵢₙ indicates risk (danger of unauthorized access to the device, low level of trust) scores of the respective devices I (i=1−the number of devices), and the right side of gᵢₙ indicates need scores, which are a combination of two entities (user i, resource j). The former one specifies that, by a label γ indicating the meaning of the score, this score indicates the risk of the device, and this score is expressed by a first-floor tensor. The latter one specifies that, by a label γ indicating the meaning of the score, the user's need to access the resource is expressed by this score, and this score is expressed by a second-floor tensor. That is, γ denotes the number of entities in one score and also indicates the type of the score.

FIG. 4 shows that some of the components of the first-floor tensor indicate the value of +1 and some of the components of the second-floor tensor indicate the value of 0. As described above, the value of 0 is a value that is set when the score is not defined for at least one of the risk or need. Further, when the access is at risk (e.g., when there is a threat), the components of the score become a negative value.

Further, the black circles in gₒᵤₜ in FIG. 4 specifically show an output of the action score a, which is a score indicating the way (action) of performing access control for each target t. FIG. 4 shows, as an example, an action score a_{1′,1′} of a target (IP1, port 1) and an action score a_{4′,1′} of a target (IP4, port 1).

In FIG. 4, a model function f_{θ} indicates the relevance between the black circles of gᵢₙ and the black circles of gₒᵤₜ, and the presence or the absence of arrows between gᵢₙ and gₒᵤₜ indicates a relation shown by the relation data. Further, the weight w^{γ} indicating the degree of the connection shown by the arrows between gᵢₙ and gₒᵤₜ is set by the policy engine 23 for every label γ indicating the meaning of the score regarding each condition c stated above. When, for example, γ=2 indicates the user's need to access a resource, the weight w^{γ=2} is expressed by a fourth-floor tensor indicated by a combination of ((IP, port), (user, resource)). The weight w^{γ} is, for example, an estimation value of the degree that the score of the risk or need expressed by the label γ contributes to the loss caused by unauthorized access or the benefit obtained by access approval.

Based on the above discussion, the action score a regarding the targets (IP1 to IPL) can be expressed by the following expression.

$$[ Expression 14 ]$$

$${a}_{{1}^{′} , {2}^{′} , … {L}^{′}} = {g}_{out} ( {\sum }_{γ ∈ Type} {w}^{γ} {\sum }_{{i}_{1} , {i}_{2} , … , {i}_{{l}_{γ}} ∈ γ} {r}_{( {1}^{′} , {2}^{′} , … , {L}^{′} ) , ( {i}_{1} , {i}_{2} , … , {i}_{γ}}^{γ} ) {g}_{in} ( {x}_{{i}_{1} , {i}_{2} , … , {i}_{γ}}^{γ} ) ) \qquad ( 14 )$$

The following expression

$$[ Expression 15 ]$$

$${g}_{in} ( {x}_{{i}_{1} , {i}_{2} , … , {i}_{γ}}^{γ} ) \qquad ( 15 )$$

on the right side of Expression (14) indicates that each component xᵢ of the score expressed by the tensor of the dimension γ is input to the input function gᵢₙ. Further, r^{γ} on the right side of Expression (14) indicates a relation between entities in the dimension γ, and is set as follows.

$$[ Expression 16 ]$$

$${r}_{( {1}^{′} , {2}^{′} , … , {L}^{′} ) , ( {i}_{1} , {i}_{2} , … , {i}_{{l}_{γ}} )}^{γ} = 0 or 1 \qquad ( 16 )$$

r=0 indicates that the entities are irrelevant to each other, and r=1 indicates that the entities are relevant to each other. Further, w_{γ} on the right side of Expression (14) is a weight parameter in the dimension γ, and is determined by the policy engine 23 performing learning. As described above, the dimension γ indicates the type of the score.

The left side of Expression (14) indicates an action score a obtained as a result of calculating the policy, and the policy engine 23 determines a discretized action for one target by the magnitude relation between the action score a and one or more types of thresholds th. As one example, when the action score is aᵢ, aᵢ is a value that may be equal to or larger than 0 but equal to or smaller than 1, and the action may have one of three kinds of values, i.e., Accept, Wait, or Drop of access, the policy engine 23 determines the actions as follows.

$$[ Expression 17 ]$$

$$If {a}_{i} > \frac{2}{3} , Action = Accept ; \\ if \frac{2}{3} \geq {a}_{i} > \frac{1}{3} , Action = Wait ; and \\ if \frac{1}{3} \geq {a}_{i} , Action = Drop \qquad ( 17 )$$

In Expression (17), a threshold th for separating Accept from Wait is ⅔ and a threshold th for separating Wait and Drop is ⅓. In this manner, the policy engine 23 determines the action in such a way that the access is not permitted as the action score becomes smaller.

In the algorithm illustrated above, the scores in the score data are expressed in a form of tensor. Since this form has extensibility for an arbitrary dimension γ, a combination of an arbitrary number of entities can be expressed. Further, when the score is not defined for at least one of the risk or need, the algorithm may set the score to be 0.

Further, as shown in Expression (14), the model function f_{θ} is a monotonic function. Further, in the algorithm, the more the action score decreases, the more the threshold th is set so that the action to be applied will not allow access.

Further, the policy engine 23 is able to specify the condition c based on data from the input unit 21 and the data store 22 and then list actions for various targets t under the above condition, thereby generating a policy. Therefore, the policy engine 23 does not need to transmit and receive access data to and from the policy enforcer 25 at the time of policy enforcement (and at the time of policy generation). Even in a case where the data from the input unit 21 and the data store 22 temporally changes, the policy engine 23 re-calculates the action score in accordance with this change, re-generate a policy, and unilaterally transmits this policy to the policy enforcer 25. Accordingly, policy enforcement for each access can be completed inside the policy enforcer 25.

Further, the administrator adjusts the weight w^{γ} through learning or the like so that the policy engine 23 can reflect the administrator's intention in the way the policy is generated, or in other words, the way in which the trade-off between the risk and needs is made. Accordingly, even when the data input from the input unit 21 is the same as the data input from the data store 22, different kinds of policies based on different intentions or security strategies, such as not only policies that achieve both avoiding risk of the device and satisfying access needs equally but also policies that give higher priority to avoiding a risk of the device, or policies that give higher priority to satisfying access needs, may be generated.

Referring once again to FIG. 3, the description will be continued. The policy engine 23 outputs the generated policy to the policy presenting unit 24 and the policy enforcer 25. While the policy engine 23 may output a policy in a form of, for example, an Access Control List (ACL) or an access proxy, the output form is not limited thereto.

The policy presenting unit 24, which is an interface for presenting the policy generated in the policy engine 23 to the administrator, includes, for example, a display unit such as a display. The policy enforcer 25 actually controls access on the network in accordance with the generated policy.

### Calculation Examples

Based on the above description of the policy generation system 20, an example of algorithm calculation for policy generation using specific values will be described below.

First, assumptions for calculations will be defined. In this example, as entities, a user ID, a device, an application, a resource, an IP address, and a port are illustrated. Further, in this example, the policy engine 23 outputs policy in an IP address-based or port-based ACL form, namely, (source IP address, destination IP address, destination port)→Action. In this form, entities in parentheses correspond to the above targets t. Further, Action may be any one of

### Accept, Wait, or Drop.

Further, scores that are automatically updated with reference to the information source are denoted by Score (User), Score (Device), Score (Application), Score (IP), Score (Port), Score (Device, Application), and Score (SrcIP, DstIP). These scores are generated by the data store 22 by an authentication history, an abnormality detection history, vulnerability information, a communication history or the like. Further, the score defined by a person using the input unit 21 is set as Score (User, Resource). This score indicates the user's need to access the resource.

Further, in this example, the dimension γ has a value from 1 to 8, and the weight parameter w^{γ} of the policy generation algorithm is set as shown in the following Expression (18).

$$[ Expression 18 ]$$

$${w}^{γ = 1} = {w}^{γ = 1} ( ( “ User ” ) , ( “ SrcIP ” , “ DstIP ” , “ DstPort ” ) ) = 1 , \\ {w}^{γ = 2} = {w}^{γ = 2} ( ( “ Device ” ) , ( “ SrcIP ” , “ DstIP ” , “ DstPort ” ) ) = 2 , \\ … \\ {w}^{γ = 7} = {w}^{γ = 7} ( ( “ SrcIP ” , “ DstIP ” ) , ( “ SrcIP ” , “ DstIP ” , “ DstPort ” ) ) = 0.5 , \\ {w}^{γ = 8} = {w}^{γ = 8} ( ( “ User ” , “ Resource ) , ( “ SrcIP ” , “ DstIP ” , “ DstPort ” ) ) = 1 \qquad ( 18 )$$

Further, the data store 22 acquires, as the relation data, True/False for a combination of all the entities, that is, between a user ID and a device, between a resource and a device, between a device and an IP address, and between a resource and a port. Note that the data store 22 may acquire True and define False for the other data that has not been acquired.

The policy engine 23 executes the aforementioned calculation based on the above acquisition information and updates the policy having a form of ACL. In this example, the policy engine 23 calculates the latest Action that should be taken for the access indicated by (SrcIp=192.168.1.10, DstIP=192.168.1.1, DstPort=1000).

First, the policy engine 23 acquires a set related to (SrcIP=192.168.1.10, DstIP=192.168.1.1, DstPort=1000) based on the relation data. The sets to be acquired are a set of users, a set of devices, a set of applications, a set of IP addresses, a set of ports, a set of (device, application), a set of (SrcIP, DstIP), and a set of (user, resource).

Specifically, for a set of the user=A, the application that uses the port 1000, IP=192.168.1.10 and 192.168.1.1, (user=A, resource=r), (SrcIP=192.168.1.10, DstIP=192.168.1.1), the relation r expressed by Expression (16) becomes 1, and for the other sets, the relation r becomes 0.

Based on the above description, the action score can be calculated as follows by using the weight parameter w^{γ} expressed in Expression (18).

$$Action Score = Score ( User = A ) * {w}^{γ = 1} + Score ( Device = 1 ) * {w}^{γ = 2} + … + Score ( SrcIP = 192.168 \text{.1} \text{.10} , DstIP = 192.168 \text{.1} \text{.1} ) * {w}^{γ = 7} + Score ( User = A , Resource = r ) * {w}^{γ = 8} = ( - 1 ) * 1 - 1 * 2 + … + 1 * 0.5 + 1 * 1 = - 1.5 \qquad ( 19 )$$

If the following expression

$$[ Expression 20 ]$$

$${g}_{out} ( t ) = \frac{1}{1 + {e}^{- t}} \qquad ( 20 )$$

is used as the monotonic function gₒᵤₜ and Expression (17) is used as the criterion for determining the action, the following expression

$${g}_{out} ( - 1.5 ) < 1 / 3 \qquad ( 21 )$$

is obtained, which means that this access is denied.

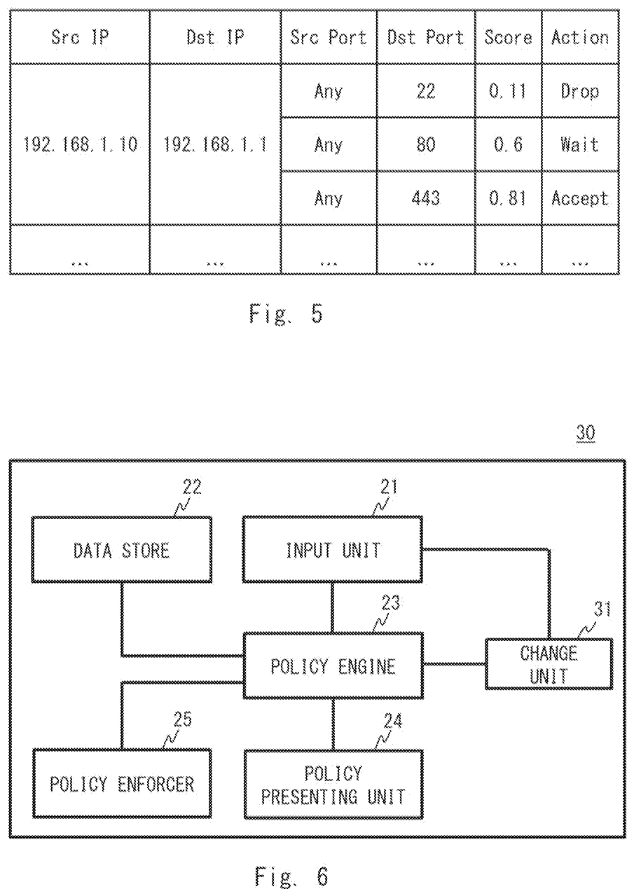

Likewise, the policy engine 23 is able to generate all the actions for SrcIP, DstIP, and Port, and list them in a form of ACL. FIG. 5 is a table which illustrates a policy in the form of ACL. FIG. 5 shows the policy in a case where (SrcIP=192.168.1.10, DstIP=192.168.1.1), SrcPort may be any one, and DstPort is 22, 80, and 443. Since the respective scores in a case where DstPort is 22, 80, and 443 are 0.11, 0.6, and 0.81, the respective actions indicate Accept, Wait, and Drop.

Further, the policy engine 23 may calculate, when access is detected, an action for this access as an access proxy, not generating actions in advance. The policy engine 23 is able to change, in accordance with the temporal change in the input data, the policy to be output.

In recent years, due to a development of techniques of a zero trust network, access control in this network has become more and more important. The zero trust network can be applied, for example, in local 5th Generation (5G) which is used in companies, municipalities, etc.

The zero trust network calculates scores regarding the security for access from all devices and determines whether or not to permit the access. According to this technique, even if a threat enters the network, it becomes possible to prevent this threat from accessing important files and prevent damage from spreading. Further, even when there is access from outside the network, the zero trust network may not uniformly block this access, and instead permit this access if it is reliable by making the above determination based on the score calculation. It is therefore possible to make the security level of the network high while maintaining network availability.

In the above zero trust network, a policy engine of the network integrates various kinds of information based on the viewpoints of risk, need, trust, etc., thereby determining an action such as Accept or Drop of access. In order to accurately determine the action, it is required to generate a specific policy. Further, even in a case where there are changes in the network environment (a plurality of elements related to access control), the policy to be generated is preferably a dynamic one so that changes in the environment can be appropriately reflected in the policy. Therefore, the policy to be generated becomes complicated, and the problem is how to define or generate such a policy.

For example, when an administrator generates a policy, he/she needs to generate the policy based on the various kinds of information described above, which increases the time and effort required to generate the policy. Further, as one example of a specific authorization algorithm for generating specific policy, it may be possible to use a decision tree and a trust score. Even in this case, however, there is a problem that the time and effort to generate a policy in order to create the decision tree will be enormous. In particular, it requires a large amount of time and effort to convert ambiguous and abstract intention of a human being into a strict and specific policy. Further, it is possible that some required policy definitions may be missing in the human work process.

On the other hand, the policy generation system 20 according to this disclosure quantifies ambiguous and abstract administrator's intention as scores based on the viewpoints of risk and operation need and causes the scores to be input from the input unit 21. Then, a strict fine policy is automatically created by the policy generation system 20 based on the score data from the input unit 21 and the data from the data store 22 and is presented to the administrator by the presenting unit 26. It is sufficient that the administrator input only the first score data as minimum settings, which means that the administrator does not need to generate specific and strict policy, whereby the time and effort that are required to generate a policy can be dramatically reduced and the policy generation system 20 is able to generate a policy in which the administrator's intention is reflected. Further, even in a case of setting missing, which means a case where an administrator does not explicitly set a policy, the policy generation system 20 is able to generate an intermediate policy to deny even access with low reliability depending on the risk level, without uniformly permitting access with low reliability, and to supplement the administrator's intention. Accordingly, the policy generation system 20 is able to generate a policy capable of making the security level of the network high while maintaining network availability, the administrator's intention being reflected in the policy. For example, the aforementioned ACL for enforcer may be generated as the policy.

When, for example, a combination of an IP address and a port has been used as the relation data, the policy engine 23 is able to generate a policy for blocking only communication where there is no need but there is a risk in accordance with dynamic changes in the situation of a user or a device. As described above, the changes in the situation of a user or a device mean changes in the user's location, a device authentication history, a time period or the like. In this case, equipment that has reached a state of very low reliability may not be allowed to access other resources and may be separated from communication. Further, equipment which has become slightly less reliable (equipment that is suspicious from a security perspective) may be prevented from performing communication in some ports, depending on the need or the importance of the resource to be accessed.

Further, the policy generation system 20 is able to not only handle information in which the relation data and the score data are combined with each other by using tensor expression, but also correct the importance of each information item by adjusting a weight. Therefore, the policy generation system 20 can handle various kinds of information, whereby the range of application can be made wide.

Further, the policy generation system 20 is able to dynamically generate a policy in accordance with background information of the current network in the form of a temporary ACL. Therefore, even when the policy enforcer 25 does not trigger the policy engine 23, access control in accordance with the background information can be executed. Therefore, it becomes possible to achieve low-latency access control.

Further, the policy generation system 20 includes the input unit 21 into which the administrator enters the score data. Therefore, the administrator is able to reflect his/her intention in the policy regarding access control.

Further, the policy engine 23 is able to generate a policy using score data in which some scores are not defined. Therefore, the policy generated by the policy engine 23 is adaptable to various situations.

Further, the policy engine 23 is also able to generate a policy in such a way that actions set by the policy are a totally ordered set and the actions become order isomorphisms for each score of score data defined by actual values. When the needs go down or the risk goes up, the action defined by the policy is changed so as not to permit access. Therefore, the policy generation system 20 is able to ensure that the administrator's intention is reflected in the action.

Further, the policy engine 23 is able to generate a policy for setting the action regarding the target of access control using score data regarding a target other than the target of access control. Therefore, the policy engine 23 is able to determine a policy with a higher accuracy.

Note that the model function according to the second example embodiment may be the one formed of multiple layers. One example of the model function in this case is as follows.

$$[ Expression 22 ]$$

$${a}_{{1}^{′} , {2}^{′} , … , {L}^{′}} = … {g}_{2} ( {\sum }_{{γ}_{1}} {w}_{{γ}_{2}}^{{( 1 )}^{{γ}_{1}}} {g}_{1} \qquad ( 22 )$$

$$( {\sum }_{γ ∈ Type} {w}_{{γ}_{1}}^{{( 0 )}^{γ}} {\sum }_{{i}_{1} , {i}_{2} , … {i}_{{l}_{λ}} ∈ γ} {r}_{( {1}^{′} , {2}^{′} , … , {L}^{′} ) , ( {i}_{1} , {i}_{2} , … , {i}_{{l}_{γ}} )}^{γ} {g}_{in} ( {x}_{{i}_{1} , {i}_{2} , … , {i}_{γ}}^{γ} ) ) ) …$$

The symbol g₁ in Expression (22) corresponds to gₒᵤₜ in Expression (14). Further, the weight parameter w in Expression (22) is a non-negative value.

### Third Example Embodiment

Hereinafter, with reference to the drawings, a third example embodiment according to this disclosure will be described. In the third example embodiment, another variation of the policy generation system 20 described in the second example embodiment will be disclosed.

The second example embodiment discloses a method in which risk or need regarding elements such as a device, a user, a resource, and a time period (or a time) are input to a policy engine as scores, whereby a trade-off therebetween is automatically evaluated in accordance with the IP address or the port number used in the actual access. Accordingly, it has become possible to automatically generate a policy (the way of performing access control) for reducing a damage in a case where this actual access is unauthorized while maintaining the benefit obtained by this actual access.

However, in the second example embodiment, an administrator does not directly define a policy, and a policy engine automatically generates all the policies from risk or need. Therefore, when any one of the generated policies is inappropriate, the administrator needs to individually change the inappropriate policy. For example, in order to meet a user's need to access, it is possible that a policy that permits access to even a high-risk device may be generated, and if the administrator cannot permit this policy, the administrator needs to change all the policies related to the high-risk device, which requires time cost.

On the other hand, the third example embodiment discloses a policy generation system in which an administrator changes only a part of the inappropriate policy, which automatically propagates changes on all the other inappropriate policies. For example, by automatically estimating that the purpose of the change is to give priority to avoiding a risk of a device, the policy generation system is able to change all the inappropriate policies. Accordingly, it is possible to reduce the cost required to change the inappropriate policy. FIG. 6 is a block diagram showing one example of a policy generation system 30 on a zero trust network. The policy generation system 30 further includes a change unit 31 in addition to the components included in the policy generation system 20.

The administrator visually recognizes the policy presented in the policy presenting unit 24, and newly inputs change information of the policy using the input unit 21 so as to correct the policy. At this time, like in the second example embodiment, the administrator may further input the score for generating this policy. The input unit 21 functions not only as means for manually setting the relation data and the scores of need and risk by the administrator as described in the second example embodiment but also as policy setting input means for receiving an input by the administrator for changing the policy or preliminarily fixing the policy. At this time, the change unit 31 adjusts the model function of the policy engine 23 in such a way that the change information input from the input unit 21 is reflected in the model function, thereby changing the policy generated temporarily.

At this time, the change unit 31 changes the policy to be generated also for the pattern of the policy that has not been changed by the change information input from the input unit 21. This change in the policy is executed even in a case where the relation data and the score data currently acquired from the input unit 21 and the data score 22 do not change before and after the input of the change information. As a result of the administrator changing the pattern of a part of policy, the model function inside the policy engine 23 is adjusted by the change unit 31 so as to implement this pattern. Accordingly, the way in which the trade-off between risk and need is made is changed in the first place, which causes a change in the policy that the administrator has not directly changed as well. Since the model function inside the policy engine 23 is adjusted, both the policy that the administrator has directly changed and the policy that the administrator has not directly changed are concurrently changed inside the policy engine 23.

It is considered that the action originally derived for an entity which is not the target that the administrator directly changes has been generated due to an inappropriate way in which the trade-off between risk and need is made.

Therefore, just like the target that the administrator directly changes, another action needs to be derived for the above entity as well under a new assumption (the way in which the trade-off is made).

As a specific example, the administrator is able to input a part of the policy as training data using the input unit 21. This training data defines the ground truth of the policy. The change unit 31 learns a weight parameter and adjusts the weight parameter in such a way that this training data is reflected in the policy. That is, the change unit 31 adjusts the weight parameter for determining the policy in such a way that the training data is reflected, as contents of change, in all the policies including the policy that has not been changed as training data.

The change unit 31 may analyze, for example, the change information on the policy that the administrator has input from the input unit 21 and compare the policy indicated by the change information with the policy generated before, thereby estimating the reason for the change. As one example, the change unit 31 automatically estimates, using change information, that the administrator's intention for the change is to give higher priority to avoiding a risk of the device, or give higher priority to satisfying access needs. The change unit 31 is able to adjust the model function inside the policy engine 23 using the above results of the estimation. Note that the change unit 31 can estimate a reason for the change by using, for example, a method such as supervised learning or clustering.

If an action that should be taken for a predetermined access (e.g., Accept or Drop) is determined in the first place, the administrator may operate the input unit 21 in such a way that this action is derived, and fix the policy (in advance) before the policy is generated.

### Calculation Example

Based on the aforementioned description of the policy generation system 30, an example of algorithm calculation for policy generation using specific values will be described. In this example, the administrator enters training data into from the input unit 21 in such a way that the action scores a become 0.9, 0.5, and 0.1, respectively, when the actions are Accept, Wait, and Drop in the calculation example in the second example embodiment.

It is assumed that the algorithm in the calculation example in the second example embodiment outputs a=0.6 for a combination of (SrcIP=192.168.1.10, DstIP=192.168.1.1, DstPort=1000) and the policy defined by the administrator regarding this combination is “Drop”. In this case, the change unit 31 updates the weight parameter by machine learning or the like so as to make the output for the same input close to y=0.1.

As described above, the change unit 31 is able to change the policy in accordance with the input by the administrator, whereby the change unit 31 is able to change the policy to an appropriate one in accordance with changes in the situation, etc. At this time, the change unit 31 may automatically change, via a weight parameter, the pattern of the policy that has not been directly changed by the administrator, thereby deriving an action that is more appropriate than the action by the original policy also for an entity that will not be changed.

Note that this disclosure is not limited to the above-described example embodiments and may be changed as appropriate without departing from the scope of this disclosure. For example, while there are two types of thresholds th in the second example embodiment, one type of threshold th or three or more types of thresholds th may be set. In the second and third example embodiments, the policy engine 23 may use, as the model function, a function other than that stated above. In this case, the policy engine 23 may learn a parameter different from the weight parameter w^{γ}.

While this disclosure has been described as a hardware configuration in the example embodiments stated above, this disclosure is not limited thereto. This disclosure may implement processing (steps) of the policy generation apparatus or the policy generation system described in the above-described example embodiments by causing a processor inside a computer to execute a computer program.

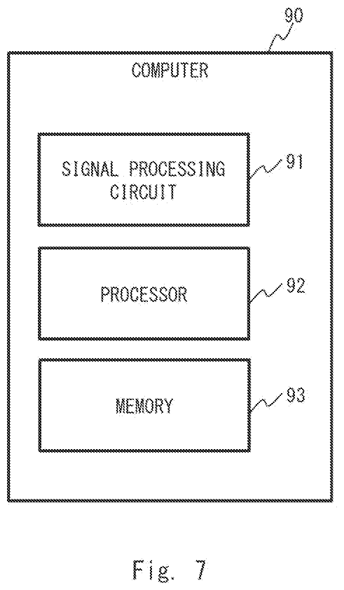

FIG. 7 is a block diagram showing a hardware configuration example of an information processing apparatus (signal processing apparatus) where the processing of each of the example embodiments stated above is executed.

Referring to FIG. 7, an information processing apparatus 90 includes a signal processing circuit 91, a processor 92, and a memory 93.

The signal processing circuit 91 is a circuit for processing signals in accordance with control performed by the processor 92. Note that the signal processing circuit 91 may include a communication circuit configured to receive signals from a transmission apparatus.

The processor 92 loads software (computer program) from the memory 93 to execute this loaded software (computer program), thereby performing processing of the apparatuses described in the above-described example embodiments. As an example of the processor 92, one of a Central Processing Unit (CPU), a Micro Processing Unit (MPU), a Field-Programmable Gate Array (FPGA), a Demand-Side Platform (DSP), or an Application Specific Integrated Circuit (ASIC) may be used, or a plurality of them may be used in parallel.

The memory 93 is composed of a volatile memory or a non-volatile memory, or a combination thereof. The number of memories 93 is not limited to one and may be plural. Note that the volatile memory may be, for example, a Random Access Memory (RAM) such as a Dynamic Random Access Memory (DRAM) or a Static Random Access Memory (SRAM). The non-volatile memory may be, for example, a Random Only Memory (ROM) such as a Programmable Random Only Memory (PROM) or an Erasable Programmable Read Only Memory (EPROM), a flash memory, or a Solid State Drive (SSD).

The memory 93 is used to store one or more instructions. The one or more instructions are stored in the memory 93 as software modules. The processor 92 loads these software modules from the memory 93 and executes these loaded software modules, thereby performing processing described in the above-described example embodiments.

Note that the memory 93 may include, besides components provided outside the processor 92, components included in the processor 92. Further, the memory 93 may include a storage located apart from the processor that forms the processor 92. In this case, the processor 92 can access the memory 93 via an Input/Output (I/O) interface.

As described above, one or more processors included in each apparatus in the above-described example embodiments executes one or more programs including instructions for causing a computer to execute the algorithm described with reference to the drawings. With this processing, the signal processing method described in each of the example embodiments may be implemented.

The program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been described above with reference to the example embodiments, the present disclosure is not limited to the statement above. Various changes that may be understood by one skilled in the art within the scope of the disclosure may be made to the configuration and the details of the present disclosure.

### REFERENCE SIGNS LIST

10 POLICY GENERATION APPARATUS
11 ACQUISITION UNIT
12 POLICY GENERATION UNIT
20, 30 POLICY GENERATION SYSTEM
21 INPUT UNIT
22 DATA STORE
23 POLICY ENGINE
24 POLICY PRESENTING UNIT
25 POLICY ENFORCEER
31 CHANGE UNIT

What is claimed is:

1. A policy generation apparatus comprising:
at least one memory configured to store instructions; and
at least one processor configured to execute the instructions to:
acquire, regarding a plurality of elements related to access control, relation data indicating a relation between the plurality of elements and score data that defines at least one of a score which is based on a viewpoint of risk of access or a score which is based on a viewpoint of a need for access; and
generate a policy for access control using the relation data and the score data.

2. The policy generation apparatus according to claim 1, wherein the at least one processor is further configured to: enable a person to enter the score data into the policy generation apparatus.

3. The policy generation apparatus according to claim 1, wherein the at least one processor is further configured to: generate the policy using the score data in which some scores are not defined.

4. The policy generation apparatus according to claim 1, wherein the at least one processor is further configured to: generate the policy in such a way that actions set by the policy are a totally ordered set and the actions become order isomorphisms for each score of the score data defined by an actual value.

5. The policy generation apparatus according to claim 1, wherein the at least one processor is further configured to: generate a policy for setting an action regarding the target of access control using the score data regarding a target other than the target of the access control.

6. The policy generation apparatus according to claim 1, wherein the at least one processor is further configured to:
present the policy to a person; and
receive an input by a person for changing the policy or preliminarily fixing the policy.

7. The policy generation apparatus according to claim 6, wherein the at least one processor is further configured to: change, by estimating a reason for the change, a pattern of the policy that has not been changed by a person's input.

8. The policy generation apparatus according to claim 6, wherein the at least one processor is further configured to: change, by adjusting a weight for determining the policy, a pattern of the policy that has not been changed by a person's input.

9. A policy generation method executed by a computer, the policy generation method comprising:
acquiring, regarding a plurality of elements related to access control, relation data indicating a relation between the plurality of elements and score data that defines at least one of a score which is based on a viewpoint of risk of access or a score which is based on a viewpoint of a need for access; and
generating a policy for access control using the relation data and the score data.

10. A non-transitory computer readable medium storing a program for causing a computer to execute the processing of:
acquiring, regarding a plurality of elements related to access control, relation data indicating a relation between the plurality of elements and score data that defines at least one of a score which is based on a viewpoint of risk of access or a score which is based on a viewpoint of a need for access; and
generating a policy for access control using the relation data and the score data.
